(19) United States
(12) Patent Application Publication
(10) Pub. No.: US 2014/0050115 A1
(43) Pub. Date: Feb. 20, 2014

(54) MOBILE COMMUNICATION METHOD AND MOBILE STATION

(71) Applicants: Hideaki Takahashi, Chiyoda-ku (JP); Tetsushi Abe, Chiyoda-ku (JP); Mikio Iwamura, Chiyoda-ku (JP)

(72) Inventors: Hideaki Takahashi, Chiyoda-ku (JP); Tetsushi Abe, Chiyoda-ku (JP); Mikio Iwamura, Chiyoda-ku (JP)

(73) Assignee: NTT DOCOMO, INC., Tokyo (JP)

(21) Appl. No.: 14/113,996

(22) PCT Filed: Apr. 23, 2012
(86) PCT No.: PCT/JP2012/060873

§ 371 Date: Oct. 25, 2013

(30) Foreign Application Priority Data
Apr. 28, 2011 (JP) 2011-102515

(51) Int. Cl. H04W 24/08

(52) U.S. Cl. CPC H04W 24/08
USPC 370/252

(57) ABSTRACT

To enable a “Measurement process” using a plurality of “Measurement Subframe Patterns”, the mobile communication method according to the present invention includes notifying the ID corresponding to a “Measurement Subframe Pattern” to a MOBILE STATION UE using an “RRC Connection Release”; receiving the ID broadcasted in a neighbor cell when the MOBILE STATION UE is in Idle mode; and performing a “Measurement process” based on a “Measurement Subframe Pattern” corresponding to the received ID when the MOBILE STATION is in Idle mode.

### TECHNICAL FIELD

The present invention relates to a mobile communication method and a MOBILE STATION.

### BACKGROUND ART

It was agreed for “Enhanced Inter Cell Interference Coordination (eICIC)” in Long Term Evolution (LTE) Release 10 that a “Measurement Subframe Pattern” is notified to a MOBILE STATION UE in Connected mode through dedicated Radio Resource Control (RRC) signaling as illustrated in FIG. 6 (see Non-patent Literature 1).

Herein, the “Measurement Subframe Pattern” is the measurement subframe pattern information indicating a subframe used so that the MOBILE STATION UE in Connected mode measures Reference Signal Received Power (RSRP) or Reference Signal Received Quality (RSRQ) in order to monitor the radio link.

On the other hand, it was not agreed for the “eICIC” in LTE Release 10 that a “Measurement Subframe Pattern” is notified to a MOBILE STATION UE in Idle mode.

However, to solve a problem in the following two cases, it is considered that it is necessary to notify the “Measurement Subframe Pattern” to a MOBILE STATION UE in Idle mode.

A first case is that a macro cell (Macro cell) and a pico cell (Pico cell) are located neighboring to each other. A second case is that a macro cell and a Closed Subscriber Group (CSG) cell are located neighboring to each other.

It is defined in LTE Release 10 that a parameter is set in a handover process in order to cause the MOBILE STATION UE in Connected mode to preferentially select a pico cell and a radio resource is time-shared in order to prevent interference such that a “Measurement process” is performed with a part of the time-shared radio resource in the first case.

In LTE Release 10 in that case, a MOBILE STATION UE in Idle mode keeps in camp-on mode of the macro cell even when approaching a pico cell because a “Measurement Subframe Pattern” is not notified to the MOBILE STATION UE in Idle mode. A handover from the macro cell to the pico cell is performed only when a handover parameter set in the wake of a “measurement report” transmitted after the measurement of the quality of the pico cell is used after the mode is switched to Connected mode in the macro cell.

Thus, there is a problem in that an unnecessary handover through the macro cell occurs after the MOBILE STATION UE in Idle mode is switched to in Connected mode in the pico cell.

Further, in the second case, a CSG cell is an interference source for a MOBILE STATION UE that does not have access to the CSG cell.

Thus, there is a problem in that a MOBILE STATION UE in Idle mode that does not have access to such a CSG cell cannot catch a camp-on cell (camp-on cell) due to the interference from the CSG cell and keeps in a state in which a station continues searching a camp-on cell (“Any cell selection”) when the MOBILE STATION UE approaches the CSG cell.

In light of the foregoing, a method in which a “Measurement Subframe Pattern” is separately notified to a MOBILE STATION UE using an “RRC Connection Release” when the MOBILE STATION UE is switched from Connected mode to Idle mode is proposed as a method for notifying a “Measurement Subframe Pattern” to such a MOBILE STATION UE in Idle mode (see Non-patent Literature 2).

For example, when it is determined using the “CSG PCI split range” included in System Information Block (SIB) 4 that the MOBILE STATION UE has approached to the CSG cell, a “Measurement process” is performed with applying the “Measurement Subframe Pattern” in such a method.

### CITATION LIST

### Non-patent Literature

Non-patent Literature 1: 3GGP contribution R2-111617

Non-patent Literature 2: 3GGP contribution R2-106578

### SUMMARY OF INVENTION

### Technical Problem

However, there is a problem in the above proposed technique in that the MOBILE STATION UE cannot recognize which “Measurement Subframe Pattern” should be applied when a plurality of “Measurement Subframe Patterns” are set in the network.

In the above proposed technique, there is a further problem in that the MOBILE STATION UE cannot recognize which cell to apply the “Measurement Subframe Pattern” when the MOBILE STATION UE approaches thereto because the MOBILE STATION UE cannot determine the type of a cell based on the PCI in each cell in the first case.

### Solution to Problem

In light of the foregoing, an objective of the present invention is to provide a mobile communication method and a MOBILE STATION that enable a “Measurement process” using a plurality of “Measurement Subframe Patterns”.

The gist of a first aspect of the present invention is a mobile communication method including notifying identification information corresponding to measurement subframe pattern information indicating a measurement subframe from a MOBILE STATION in a camp-on mode to a MOBILE STATION using a connection release signal; receiving identification information broadcasted in a neighbor cell when the MOBILE STATION is in a camp-on mode; and performing a measurement process based on measurement subframe pattern information corresponding to the received identification information when the MOBILE STATION is in a camp-on mode.

The gist of a second aspect of the present invention is a MOBILE STATION including a receiving unit configured to receive identification information corresponding to measurement subframe pattern information indicating a measurement subframe from a MOBILE STATION in a camp-on mode using a connection release signal; and a measuring unit configured to perform a measurement process when the MOBILE STATION is in a camp-on mode. The receiving unit is configured to receive identification information broadcasted in a neighbor cell when the MOBILE STATION is in a camp-on mode, and the measuring unit is configured to perform the measurement process based on measurement subframe pattern information corresponding to the received identification information.

### BRIEF DESCRIPTION OF DRAWINGS

FIG. 1 is a view of the whole structure of a mobile communication system according to a first embodiment of the present invention.

FIG. 2 is a functional block diagram of a RADIO BASE STATION according to the first embodiment of the present invention.

FIG. 3 is a functional block diagram of a MOBILE STATION according to the first embodiment of the present invention.

FIG. 4 is a view for describing the operation in the mobile communication system according to the first embodiment of the present invention.

FIG. 5 is a sequence diagram of the operation in the mobile communication system according to the first embodiment of the present invention.

FIG. 6 is a view for a mobile communication system according to a prior art.

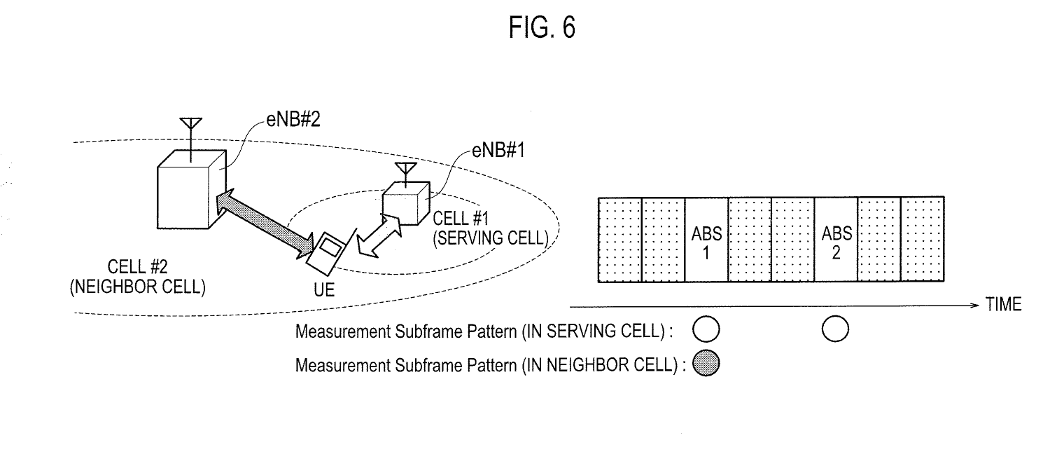

### DESCRIPTION OF EMBODIMENTS

### (Mobile Communication System According to the First Embodiment of the Present Invention)

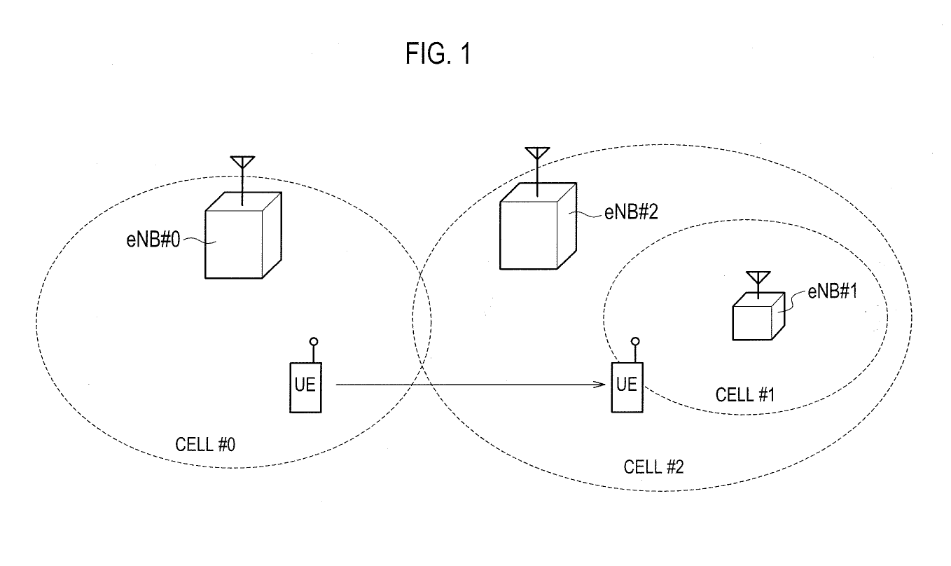

Next, a mobile communication system according to a first embodiment of the present invention will be described with reference to FIGS. 1 to 5. Although an LTE mobile communication system is cited and described as an example of the mobile communication system according to the present embodiment, the present invention is applicable to another mobile communication system other than an LTE mobile communication system.

The mobile communication system according to the present embodiment is configured to perform an “eICIC” therein.

As illustrated in FIG. 1, the mobile communication system according to the present embodiment includes a RADIO BASE STATION eNB#0 that manages a cell #0, a RADIO BASE STATION eNB#1 that manages a cell #1, and a RADIO BASE STATION eNB#2 that manages a cell #2.

Here, the cells #0 and #2 can be any of a macro cell, a pico cell, and a CSG cell. Note that the pico cell can also be referred to as a femto (Femto) cell, a micro (Micro) cell, or the like.

The cell #1 is a pico cell or a CSG cell and the cell #2 is a macro cell in the mobile communication system according to the present embodiment.

Further, in the mobile communication system according to the present embodiment, a MOBILE STATION UE is switched from Connected mode to Idle mode in the cell #0 so that the MOBILE STATION UE is in Idle mode in the cell #2.

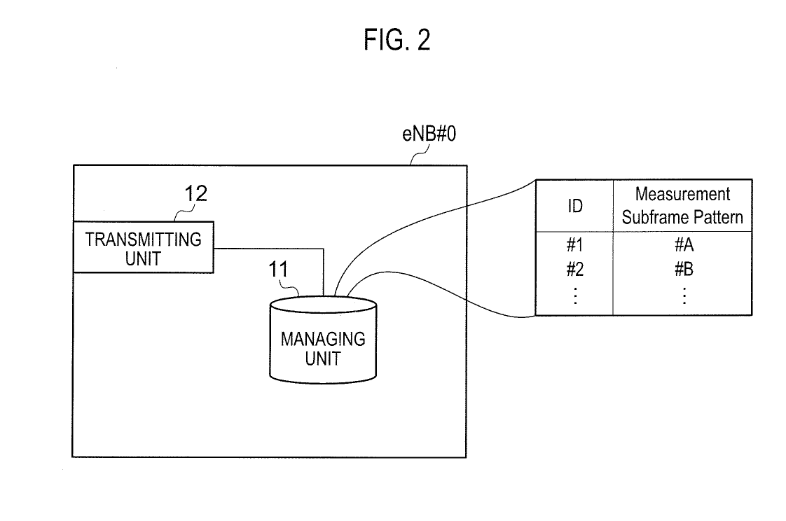

As illustrated in FIG. 2, the RADIO BASE STATION eNB#0 includes a managing unit 11, and a transmitting unit.

As illustrated in FIG. 2, the managing unit 11 is configured to store the record for linking an “ID” with a “Measurement Subframe Pattern”. In other words, the managing unit 11 is configured to manage a “Measurement Subframe Pattern” corresponding to each ID.

In that case, the “Measurement Subframe Pattern” means measurement subframe pattern information indicating one or a plurality of subframes from among the subframes set as Almost Blank Subframes (ABS) in each cell.

The transmitting unit 12 is configured to notify an ID corresponding to the “Measurement Subframe Pattern” to the MOBILE STATION UE using the “RRC connection Release”.

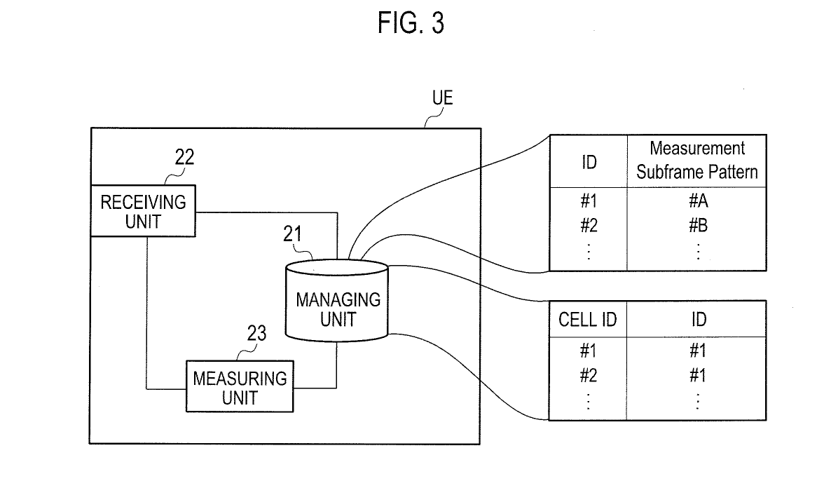

As illustrated in FIG. 3, the MOBILE STATION UE includes a managing unit 21, a receiving unit 22, and a measuring unit 23.

The receiving unit 22 is configured to receive various signals from RADIO BASE STATIONs eNB.

For example, as illustrated FIG. 1, the receiving unit 22 receives the “RRC Connection Release” from the RADIO BASE STATION eNB#0 and receives broadcast INFORMATION (System Information (SI)) from the RADIO BASE STATIONs eNB#1 and eNB#2.

As illustrated in FIG. 3, the managing unit 21 is configured to store the record for linking an “ID” with a “Measurement Subframe Pattern”.

In other words, the managing unit 21 is configured to manage a “Measurement Subframe Pattern” corresponding to each ID based on the “RRC Connection Release” received with the receiving unit 22.

As illustrated in FIG. 3, the managing unit 21 is further configured to store the record for linking a “cell ID” with an “ID”.

In other words, the managing unit 21 is configured to manage the ID transmitted in each cell based on the ID included in the broadcast INFORMATION received with the receiving unit 22.

The measuring unit 23 is configured to perform a “Measurement process” in each cell based on the “Measurement Subframe Pattern” corresponding to the ID transmitted in each cell.

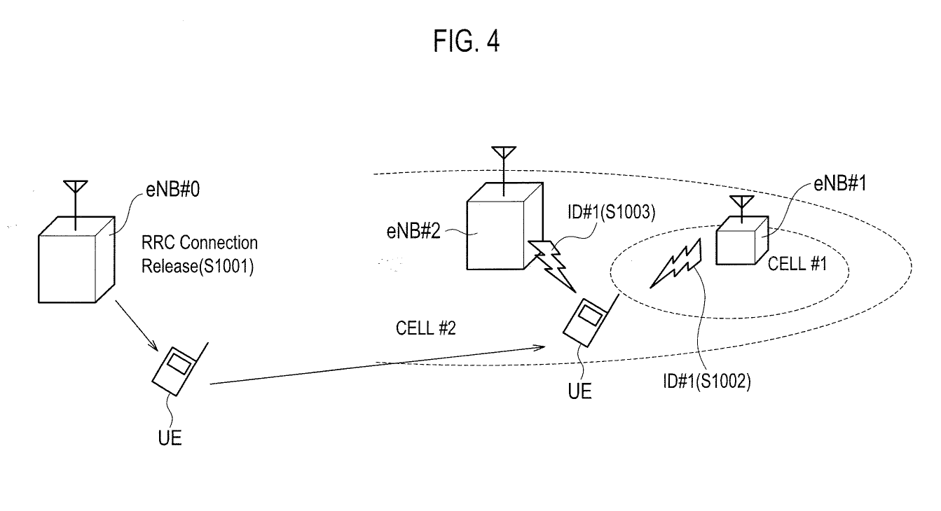

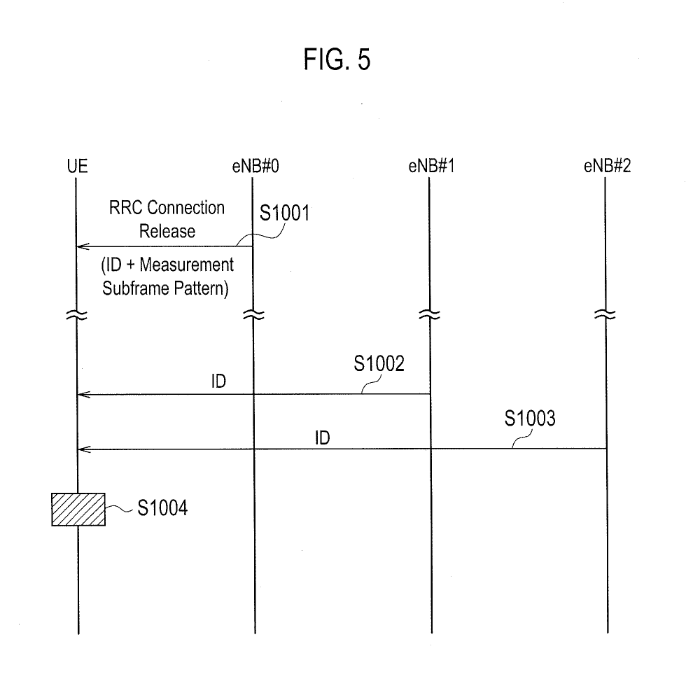

Hereinafter, the operation of the mobile communication system according to the present embodiment will be described with reference to FIGS. 4 and 5.

As illustrated in FIGS. 4 and 5, in step S1001, the RADIO BASE STATION eNB#0 transmits the “RRC Connection Release” to the MOBILE STATION UE that is in Connected mode in the cell #0.

At that time, the RADIO BASE STATION eNB#0 notifies the “Measurement Subframe Pattern” corresponding to each ID to the MOBILE STATION UE using the “RRC Connection Release”.

After that, when being in Idle mode in the cell #2, the MOBILE STATION UE obtains an “ID #1” from the broadcast INFORMATION in the cell #1 in step S1002, and obtains an “ID #1” from the broadcast INFORMATION in the cell #2 in step S1003.

In step S1004, the MOBILE STATION UE in Idle mode performs a “Measurement process” based on a “Measurement Subframe Pattern #A” corresponding to the “ID #1” in the cell #1, and performs a “Measurement process” based on a “Measurement Subframe Pattern #A” corresponding to the “ID #1” in the cell #2.

According to the mobile communication system of the present embodiment, the MOBILE STATION UE is configured to perform a “Measurement process” based on the “Measurement Subframe Pattern” corresponding to the ID broadcasted in each cell after obtaining the “Measurement Subframe Pattern” corresponding to each ID using the “RRC Connection Release”.

As a result of it, the MOBILE STATION UE can determine a “Measurement Subframe Pattern” to be applied even when a plurality of “Measurement Subframe Patterns” are set in the network.

Further, even in the first case (in other words, the case in which there are both a macro cell and a pico cell), the MOBILE STATION UE can apply the “Measurement Subframe Pattern” corresponding to the ID broadcasted in the cell to which the MOBILE STATION UE has approached.

The above-described aspects in the present embodiment can also be expressed as the following.

A first aspect of the present embodiment is a mobile communication method including notifying the ID (identification information) corresponding to a “Measurement Subframe Pattern (measurement subframe pattern information)” indicating a measurement subframe from a MOBILE STATION UE in Idle mode (a camp-on mode) to a MOBILE STATION UE using an “RRC Connection Release (connection release signal)”; receiving ID broadcasted in a neighbor cell (for example, a cell #1 or a cell #2) when the MOBILE STATION UE is in Idle mode; and performing a “Measurement process (measurement process)” based on the “Measurement Subframe Pattern” corresponding to the received ID when the MOBILE STATION UE is in Idle mode.

The gist of a second aspect of the present embodiment is a MOBILE STATION UE including a receiving unit 22 configured to receive the ID corresponding to a “Measurement Subframe Pattern” using an “RRC Connection Release”; and a measuring unit 23 configured to perform a “Measurement process” when the MOBILE STATION UE is in Idle mode. The receiving unit 22 is configured to receive the ID broadcasted in a neighbor cell when the MOBILE STATION UE is in Idle mode, and the measuring unit 23 is configured to perform the “Measurement process” based on the “Measurement Subframe Pattern” corresponding to the received ID.

According to the first and second aspect in the present embodiment, the “Measurement Subframe Pattern” can indicate one or a plurality of subframes from among the subframes set as Almost Blank Subframes (ABS) in the neighbor cell.

The above-mentioned operations of the RADIO BASE STATIONs eNB#0/eNB#1/eNB#2 and the MOBILE STATION UE can be implemented with hardware, can be implemented with a software module executed with the processor, or can be implemented with the combination thereof.

The software module can be provided in an arbitrary format storage medium such as a random access memory (RAM), a flash memory, a read only memory (ROM), an erasable programmable ROM (EPROM), an electrically erasable and programmable ROM (EEPROM), a register, a hard disk, a removal disk, and a CD-ROM.

The storage medium is connected to a processor such that the processor can read and write information from/to the storage medium. The storage medium can be integrated in a processor. The storage medium and the processor can be provided in an ASIC. The ASIC can be provided in the RADIO BASE STATIONs eNB#0/eNB#1/eNB#2 and the MOBILE STATION UE. Each of the storage medium and the processor can be provided in the RADIO BASE STATIONs eNB#0/eNB#1/eNB#2 and the MOBILE STATION UE as a discrete component.

The present invention has been described in detail above with the embodiment. However, it is obvious for a person with an ordinary skill in the art that the present invention is not limited to the embodiment described herein. The present invention can be modified or altered without departing from the gist and scope of the invention defined by the description of the claims. Thus, the description herein is aimed at describing examples and does not mean any limitations on the present invention.

Note that Japanese Patent Application No. 2011-102515 (filed Apr. 28, 2011) is incorporated herein by reference in its entirety.

### INDUSTRIAL APPLICABILITY

As described above, the present invention can provide a mobile communication method and a MOBILE STATION that enable a “Measurement process” using a plurality of “Measurement Subframe Patterns”.

### Reference Signs List

eNB#0, eNB#1, eNB#2 RADIO BASE STATION
UE MOBILE STATION
11, 21 managing unit
12 transmitting unit
22 receiving unit
23 measuring unit

1. A mobile communication method comprising:
notifying identification information corresponding to measurement subframe pattern information indicating a measurement subframe from a MOBILE STATION in a camp-on mode to a MOBILE STATION using a connection release signal;
receiving identification information broadcasted in a neighbor cell when the MOBILE STATION is in a camp-on mode; and
performing a measurement process based on measurement subframe pattern information corresponding to the received identification information when the MOBILE STATION is in a camp-on mode.

2. The mobile communication method according to claim 1, wherein the measurement subframe pattern information indicates one or a plurality of subframes from among subframes set as Almost Blank Subframes (ABS) in the neighbor cell.

3. A MOBILE STATION comprising:
a receiving unit configured to receive identification information corresponding to measurement subframe pattern information indicating a measurement subframe from a MOBILE STATION in a camp-on mode using a connection release signal; and
a measuring unit configured to perform a measurement process when the MOBILE STATION is in a camp-on mode, wherein
the receiving unit is configured to receive identification information broadcasted in a neighbor cell when the MOBILE STATION is in a camp-on mode, and
the measuring unit is configured to perform the measurement process based on measurement subframe pattern information corresponding to the received identification information.

4. The MOBILE STATION according claim 3, wherein the measurement subframe pattern information indicates one or a plurality of subframes from among subframes set as Almost Blank Subframes (ABS) in the neighbor cell.
